(19) United States
(12) Patent Application Publication
(10) Pub. No.: US 2022/0150675 A1
(43) Pub. Date: May 12, 2022

(54) COMMUNICATION TERMINAL

(71) Applicant: SHARP KABUSHIKI KAISHA, Sakai City, Osaka (JP)

(72) Inventors: Takashi SAKAMOTO, Sakai City, Osaka (JP); KATSUO DOI, Sakai City, Osaka (JP); KEN NAKASHIMA, Sakai City, Osaka (JP); TAKEHIKO NAKAGAWA, Sakai City, Osaka (JP); Shota TSUBOKURA, Sakai City, Osaka (JP)

(73) Assignee: SHARP KABUSHIKI KAISHA, Sakai City, Osaka (JP)

(21) Appl. No.: 17/435,377

(22) PCT Filed: Jul. 30, 2019
(86) PCT No.: PCT/JP2019/029787

§ 371 Date: Aug. 31, 2021

(30) Foreign Application Priority Data
Mar. 8, 2019 (JP) 2019-042591

(51) Int. Cl. H04W 4/38; H04L 67/12; G01P 15/097

(52) U.S. Cl. CPC H04W 4/38; G01P 15/097; H04L 67/12

(57) ABSTRACT

A communication terminal includes an acceleration sensor, a position acquisition antenna, a communication interface, and a processor. The processor transmits acceleration information acquired using the acceleration sensor and present position information acquired using the position acquisition antenna in a normal operation mode via the communication interface. The processor changes to an abnormal state when detecting a vibration equal to or higher than a first predetermined value using the acceleration sensor, and increases a frequency of acquisition or transmission of the acceleration information or the present position information in the abnormal state.

### TECHNICAL FIELD

The present invention relates to technology of a communication terminal to be mounted on an automobile, a motorcycle, or the like, and having an acceleration sensor, a present position acquisition function, and the like.

### BACKGROUND ART

Conventionally, techniques for detecting or preventing vehicle thefts have been known. For example, JP 2018-136754 A (PTL 1) discloses an information processing device and a mobility data collection system. According to PTL 1, the information processing device includes a storage processing unit that stores probe information received from a vehicle in a storage unit according to predetermined collection conditions, a model generation unit that generates a model for determining whether an event that is a condition for delivering service information regarding a certain service to be delivered to the vehicle has occurred based on the stored probe information, a model evaluation unit that determines whether the event included in the service information delivered according to the generated model has occurred with a predetermined accuracy, and a deletion unit that deletes probe information that is not used by other services among the pieces of stored probe information when it is determined that the event has occurred with the predetermined accuracy.

JP 2018-128710 A (PTL 2) discloses a control device, a control method, and a program for the control device. According to PTL 2, the control device acquires, for a plurality of event-encountered vehicles that have encountered traffic events, a plurality of pieces of pre-event-encountered information based on at least pieces of event-encountered vehicle surrounding information, each of the event-encountered vehicle surrounding information indicates the surrounding conditions of the event-encountered vehicle a predetermined time before the event, acquires present own vehicle present information based on at least own vehicle surrounding information indicating the surrounding conditions of the own vehicle, and operates an output means of the own vehicle when there is information satisfying a similar criterion set in advance for the own vehicle present information in the plurality of pieces of pre-event-encountered information.

JP 2018-112838 A (PTL 3) discloses a driving data collection system, a driving data collection center, an in-vehicle terminal, and a sub-collection device. According to PTL 3, the driving data collection system includes an in-vehicle terminal that is mounted on a vehicle and includes a driving data acquisition unit that acquires driving data and a transmission unit that transmits the driving data acquired by the driving data acquisition unit, and a driving data collection center including a receiving unit that collects driving data transmitted from the in-vehicle terminals of a plurality of vehicles, and the driving data collection center includes a target road table generation unit that determines, for each of the plurality of vehicles, links for collecting driving data from a plurality of vehicles according to the driving frequency of the plurality of vehicles for each road section, and a transmission unit that transmits a target road table for acquiring driving data by the in-vehicle terminal of each of the plurality of vehicles at the link determined for each of the plurality of vehicles by the target road table generation unit to the in-vehicle terminal of each of the plurality of vehicles.

### CITATION LIST

### Patent Literature

PTL 1: JP 2018-136754 A

PTL 2: JP 2018-128710 A

PTL 3: JP 2018-112838 A

### Summary of Invention

### TECHNICAL PROBLEM

An object of the present invention is to provide a technique for reducing the amount of communication data.

### Solution to Problem

According to an aspect of the invention, a communication terminal including an acceleration sensor, a position acquisition antenna, a communication interface, and a processor is provided. The processor transmits acceleration information acquired using the acceleration sensor and present position information acquired using the position acquisition antenna in a normal operation mode via the communication interface, changes to an abnormal state when detecting a vibration equal to or higher than a first predetermined value using the acceleration sensor, and increases a frequency of the acquisition or transmission of the acceleration information or the present position information in the abnormal state.

### Advantageous Effects of Invention

As described above, according to the present invention, a technique for reducing the amount of communication data is provided.

### BRIEF DESCRIPTION OF DRAWINGS

FIG. 1 is a conceptual diagram illustrating an overall configuration of a network system 1 according to a first embodiment.

FIG. 2 is a block diagram illustrating a configuration of a first communication terminal 200 according to the first embodiment.

FIG. 3 is a conceptual diagram illustrating history data 221 according to the first embodiment.

FIG. 4 is a conceptual diagram illustrating various flag data 222 according to the first embodiment.

FIG. 5 is a conceptual diagram illustrating various parameter data 223 according to the first embodiment.

FIG. 6 is a conceptual diagram illustrating predetermined position data 224 according to the first embodiment.

FIG. 7 is a conceptual diagram illustrating a relationship between changes in battery voltage and changes in vibration when an engine is being started and when the engine is stopped according to the first embodiment.

FIG. 8 is a conceptual diagram illustrating a relationship between normal operation mode and sleep mode in the first communication terminal 200 according to the first embodiment.

FIG. 9 is a flowchart illustrating information processing related to switching between the normal operation mode and the sleep mode in the first communication terminal 200 according to the first embodiment.

FIG. 10 is a flowchart illustrating information processing related to acquisition of firmware update data in the first communication terminal 200 according to the first embodiment.

FIG. 11 is a block diagram illustrating a configuration of a server 100 according to the first embodiment.

FIG. 12 is a conceptual diagram illustrating user information data 121 according to the first embodiment.

FIG. 13 is a conceptual diagram illustrating a data structure of history data 122 according to the first embodiment.

FIG. 14 is a sequence diagram illustrating a processing procedure of the server 100 according to the first embodiment.

FIG. 15 is a block diagram illustrating a configuration of a second communication terminal 300 according to the first embodiment.

FIG. 16 is a flowchart illustrating information processing related to switching between the normal operation mode and the sleep mode in the first communication terminal 200 according to a third embodiment.

FIG. 17 is a flowchart illustrating information processing related to acquisition of program update data in the first communication terminal 200 according to a fourth embodiment.

FIG. 18 is a flowchart illustrating information processing related to acquisition of program update data in the first communication terminal 200 according to a fifth embodiment.

### DESCRIPTION OF EMBODIMENTS

Embodiments of the present invention will be described below with reference to the drawings. In the following description, identical components will be given identical reference signs. Respective names and functions of the components will also be identical. Thus, detailed descriptions will not be repeated for the components.

### First Embodiment

### Overall Configuration of Network System

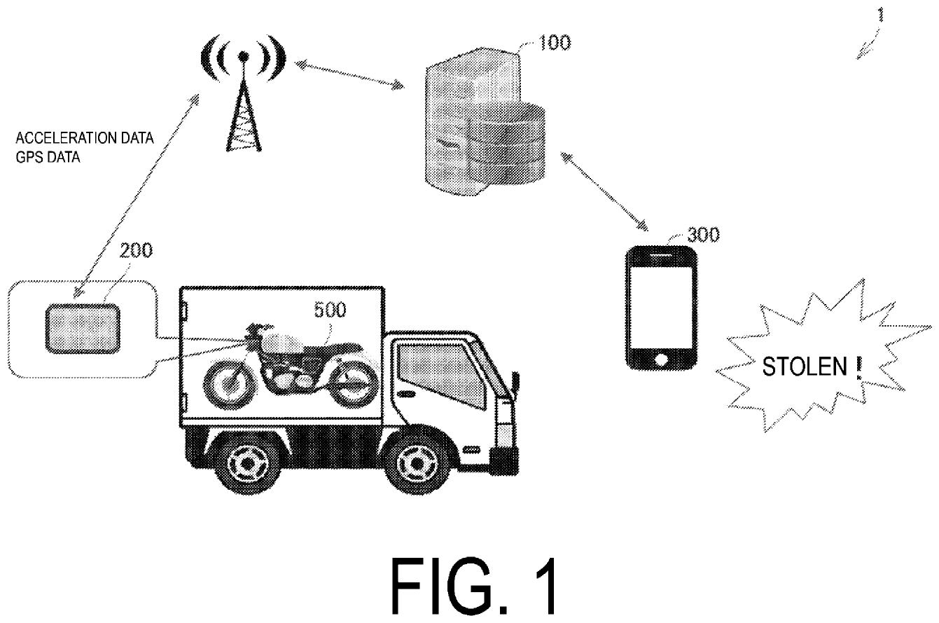

First, an overall configuration of a network system 1 according to the present embodiment will be described. Referring to FIG. 1, the network system 1 mainly includes a server 100 connected to the Internet for providing a vehicle state providing service, first communication terminals 200 mounted on respective various vehicles 500 registered in the vehicle state providing service, and second communication terminals 300 of respective users who receive the vehicle state providing service. The network system 1 according to the present embodiment provides the vehicle state providing service to the plurality of users and the plurality of second communication terminals 300 using various measurement data to be measured by the plurality of first communication terminals 200 mounted on the respective plurality of vehicles 500.

For example, each of the first communication terminals 200 uploads the present position, posture, vibration, speed, battery voltage, and the like of the vehicle 500 to the server 100. Thereby, the server 100 determines whether the vehicle 500 is likely to have been stolen. Then, when it is determined that the vehicle 500 is likely to have been stolen, the server 100 transmits a warning notification to the second communication terminal 300 of the user who owns the vehicle 500.

### Configuration of First Communication Terminal 200

Hereinafter, configurations and functions of the devices constituting the network system 1 according to the present embodiment will be described. First, the configuration of the first communication terminal 200 mounted on the vehicle 500 in the network system 1 according to the present embodiment will be described.

The first communication terminal 200 is mounted on the vehicle 500 such as an automobile, a motorcycle, a bicycle, or a water vehicle. In the present embodiment, the first communication terminal 200 is configured to be driven by the voltage of a battery of the vehicle 500 and to be able to measure the voltage of the battery. More specifically, the first communication terminal 200 is preferably mounted on the vehicle 500 at a predetermined position and in a predetermined posture in order to accurately measure the posture and the like of the vehicle 500. However, by driving the vehicle 500 for a few minutes with the first communication terminal 200 mounted, the posture of the first communication terminal 200 with respect to the posture of the vehicle 500 is specified in advance, thereby the posture of the vehicle 500 may be calculated based on the subsequent posture of the first communication terminal 200.

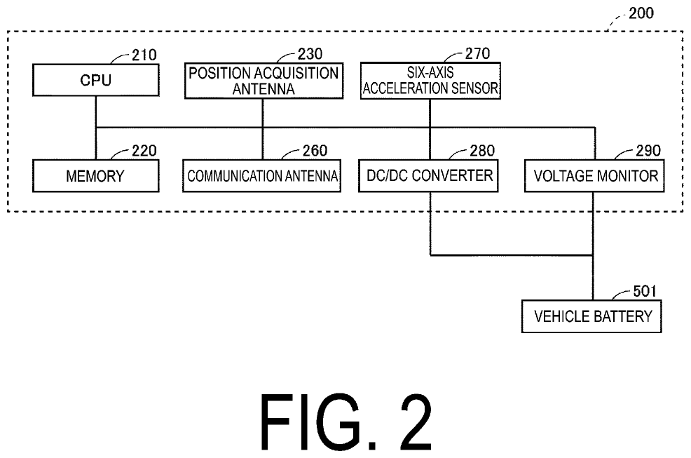

Referring to FIG. 2, the first communication terminal 200 mainly includes a central processing unit (CPU) 210, a memory 220, a position acquisition antenna 230, a communication antenna 260, a six-axis acceleration sensor 270, a DC/DC converter 280, a battery voltage monitor 290, and the like.

More specifically, the CPU 210 controls the respective units of the first communication terminal 200 based on a control program and data to be stored in the memory 220. For example, the CPU 210 executes various types of information processing described later while referring to various data according to the control program.

The memory 220 is constituted of various random access memories (RAMs), various read-only memories (ROMs), and the like, and stores the control program and the various data.

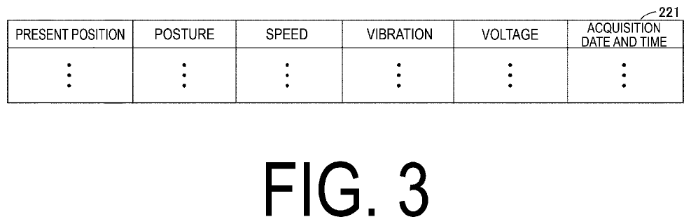

For example, in the present embodiment, the memory 220 stores history data 221 as illustrated in FIG. 3. Every time the CPU 210 measures the present position information, the acceleration information, and the like, the CPU 210 stores a correspondence between the present position information, the orientation and inclination (posture) of the vehicle, the speed, information indicating magnitude of the vibration of the vehicle 500, the voltage of the battery 501, and the acquisition date and time of these pieces of information as the history data 221. Note that the CPU 210 may acquire and store only the acceleration, store only the vibration, or acquire and store only the present position information. Alternatively, the timing or frequency of the storage of the present position information may be different from the timing or frequency of the storage of the vibration.

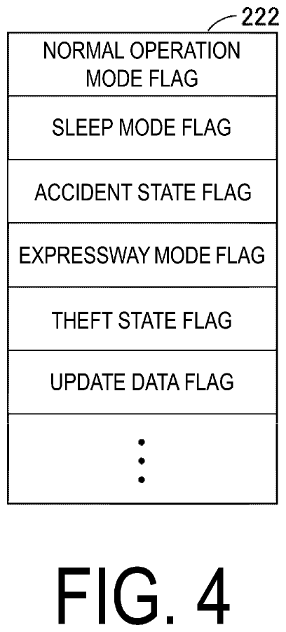

In the present embodiment, the memory 220 stores flag data 222 as illustrated in FIG. 4. As the flag data 222, the memory 220 stores a flag indicating that the vehicle is in normal driving mode, a flag indicating that the vehicle is in sleep mode, a flag indicating that the vehicle is in warning mode in which an accident such as a collision is likely to have occurred, a flag indicating a mode in which the change in posture is small such as when driving on an expressway, a flag indicating that the vehicle is likely to have been stolen, a flag indicating that there is new firmware update data to be downloaded and installed from the server, flags indicating other states, and the like.

Note that, as described later, the CPU 210 of the first communication terminal 200 may determine whether the vehicle 500 is in normal driving mode and turn on/off the corresponding flag, or may turn on/off the flag based on an instruction from the server 100. The CPU 210 may determine whether the vehicle is in sleep mode and turn on/off the corresponding flag, or may turn on/off the flag based on an instruction from the server 100. The CPU 210 may determine whether the vehicle 500 is in warning mode in which an accident such as a collision is likely to have occurred and turn on/off the corresponding flag, or may turn on/off the flag based on an instruction from the server 100. The CPU 210 may determine whether the vehicle 500 is in mode in which the change in posture is small such as driving on an expressway and turn on/off the corresponding flag, or may turn on/off the flag based on an instruction from the server 100. The CPU 210 may determine whether the vehicle 500 is likely to have been stolen and turn on/off the corresponding flag, or may turn on/off the flag based on an instruction from the server 100. Additionally, in the normal driving mode, the CPU 210 may turn on the update data flag of the memory 220 when the CPU 210 receives data indicating that there is program update data from the server 100 via the communication antenna 260, and may turn off the flag when the download and installation of the update data is completed.

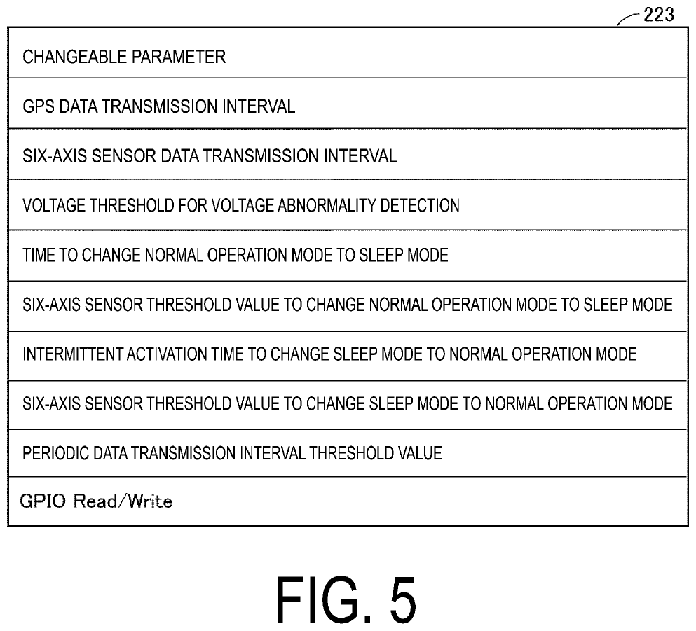

In addition, in the present embodiment, as illustrated in FIG. 5, the memory 220 stores, as various parameter data 223, an upload interval of present position information to the server 100, upload intervals of acceleration and vibration to the server 100, a threshold value for detecting an abnormality in a remaining battery level, a predetermined period of time for determining whether to change from the normal operation mode to the sleep mode, a vibration level for determining whether to change from the normal operation mode to the sleep mode, an intermittent activation time for returning from the sleep mode to the normal operation mode, a vibration level for determining whether to change from the sleep mode to the normal operation mode, other periodic data transmission intervals, and the like.

Note that in the present embodiment, various parameters in the first communication terminal 200 can be changed from the server 100 or the like on the cloud. For example, as illustrated in FIG. 5, based on the instruction from the server 100 via the communication antenna 260, the CPU 210 of the first communication terminal 200 changes the upload interval of the present position information to the server 100, changes the upload intervals of the acceleration and the vibration to server 100, changes the threshold value for detecting the abnormality in the remaining battery level, changes the predetermined period of time for determining whether to change from the normal operation mode to the sleep mode, changes the vibration level for determining whether to change from the normal operation mode to the sleep mode, changes the intermittent activation time for returning from the sleep mode to the normal operation mode, changes the vibration level for determining whether to change from the sleep mode to the normal operation mode, or changes other periodic data transmission intervals.

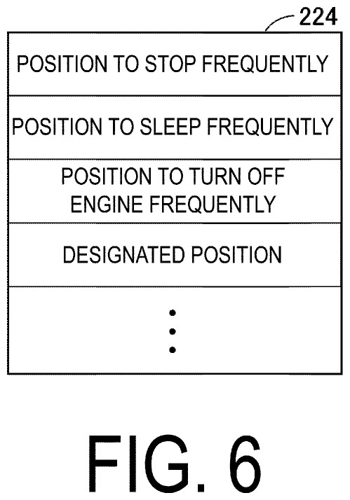

In addition, in the present embodiment, the memory 220 stores predetermined position data 224 as illustrated in FIG. 6. The predetermined position data 224 stores information regarding a position where the first communication terminal 200 or the vehicle 500 often stops, a position where the first communication terminal 200 or the vehicle 500 is likely to change to the sleep mode, a position where the engine is often turned off, a position designated by an instruction from the user or the server 100, and the like. For example, in the present embodiment, when a period of time in which the vibration is determined to be small using the acceleration sensor 270 is long, the CPU 210 acquires the present position using the position acquisition antenna 230 and stores the acquired present position in the predetermined position data 224. Alternatively, when changing to the sleep mode as described later, the CPU 210 acquires the present position using the position acquisition antenna 230 and stores the acquired present position in the predetermined position data 224.

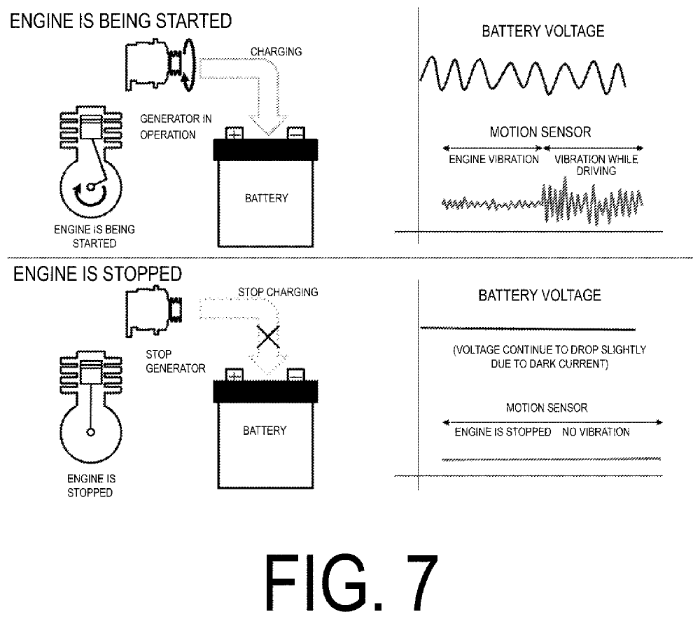

Alternatively, when determining that the engine is stopped by various methods such as the voltage of the battery 501 of the vehicle 500 becomes constant, the CPU 210 acquires the present position using the position acquisition antenna 230 and stores the acquired present position in the predetermined position data 224. More specifically, as illustrated in FIG. 7, in the present embodiment, when the engine of the vehicle 500 is being started, the acceleration sensor 270 detects a small vibration caused by the engine and inputs the detected small vibration to the CPU 210. On the other hand, while driving the vehicle 500, the acceleration sensor 270 detects a large vibration caused by a jolt of the vehicle 500 and inputs the detected large vibration to the CPU 210. Further, since the voltage of the battery 501 rises and falls while the engine of the vehicle 500 is being started, the battery voltage monitor 290 inputs values of fluctuating voltages to the CPU 210. Note that while the engine of the vehicle 500 is stopped, the voltage of the battery 501 hardly fluctuates. That is, the CPU 210 may determine that the engine of the vehicle 500 is stopped when the vibration is small and the voltage fluctuation is small.

Alternatively, when receiving a command to specify a predetermined position from the server 100 via the communication antenna 260, the CPU 210 stores the specified predetermined position in the predetermined position data 224. For example, a user's home address, a service area location, a gas station location, and the like are provided.

Returning to FIG. 2, the position acquisition antenna 230 is, for example, a global navigation satellite system (GNSS) antenna, and provides signals acquired from the satellite to the CPU 210. Based on the signals, the CPU 210 calculates the present position and time of the first communication terminal 200, that is, the vehicle 500, and stores the calculated present position and time in the history data 221 and uploads the calculated present position and time to the server 100 using the communication antenna 260.

The acceleration sensor 270 periodically measures the posture and vibration of the vehicle 500, that is, the posture and vibration of the first communication terminal 200 itself mounted on the vehicle 500 in a predetermined posture, and periodically inputs the measurement data to the CPU 210. The CPU 210 calculates the posture and vibration of the first communication terminal 200, that is, the vehicle 500, and stores the calculated posture and vibration in the history data 221, and uploads the calculated posture and vibration to the server 100 using the communication antenna 260.

The DC/DC converter 280 supplies electric power from the battery 501 to the respective units of the first communication terminal 200.

The battery voltage monitor 290 measures the voltage of the battery 501 and outputs the measurement result to the CPU 210.

The communication antenna 260 includes, for example, an UTE antenna, a SIM card, or the like, and transmits and/or receives data to/from the server 100 via a carrier network, the Internet, or another communication terminal. For example, the CPU 210 periodically uploads the present position information acquired by the position acquisition antenna 230, the posture and vibration information acquired by the acceleration sensor 270, the voltage information measured by the battery voltage monitor 290, and the like to the server 100 using the communication antenna 260.

### Information Processing in First Communication Terminal 200

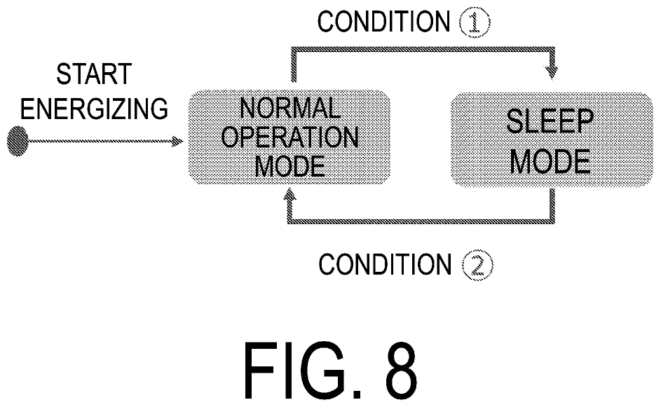

Next, information processing in the first communication terminal 200 according to the present embodiment will be described. In the present embodiment, as illustrated in FIG. 8, the first communication terminal 200 periodically acquires the present position information and the acceleration and vibration information in the normal driving mode and transmits the acquired information to the server 100, and changes to the sleep mode when vibration is not detected for a predetermined time. Note that in the sleep mode, the first communication terminal 200 periodically activates the acceleration sensor 270, the position acquisition antenna 230, the communication antenna 260, and the like to acquire various data and transmits the acquired data to the server 100 at a frequency lower than that in the normal driving mode.

More specifically, in the present embodiment, in the sleep mode, the first communication terminal 200 suspends the communication with the server 100, and measures the vibration by the acceleration sensor 270 and stores the measurement data in the memory 220. However, also in the sleep mode, the first communication terminal 200 may acquire the present position information by the position acquisition antenna and store acquired data in the memory 220. Alternatively, also in the sleep mode, the first communication terminal 200 may transmit the present position information and the acceleration information at a frequency lower than that in the normal mode or with a data amount less than that in the normal mode.

Further, in the present embodiment, as will be described later, when there is program update data such as firmware, the first communication terminal 200 downloads and installs the program update data before changing to the sleep mode.

Furthermore, in the present embodiment, as will be described later, in the normal mode, the first communication terminal 200 reduces the frequency of transmitting the measurement result by the acceleration sensor, and increases the frequency of transmitting the measurement result by the acceleration sensor when a large vibration is detected.

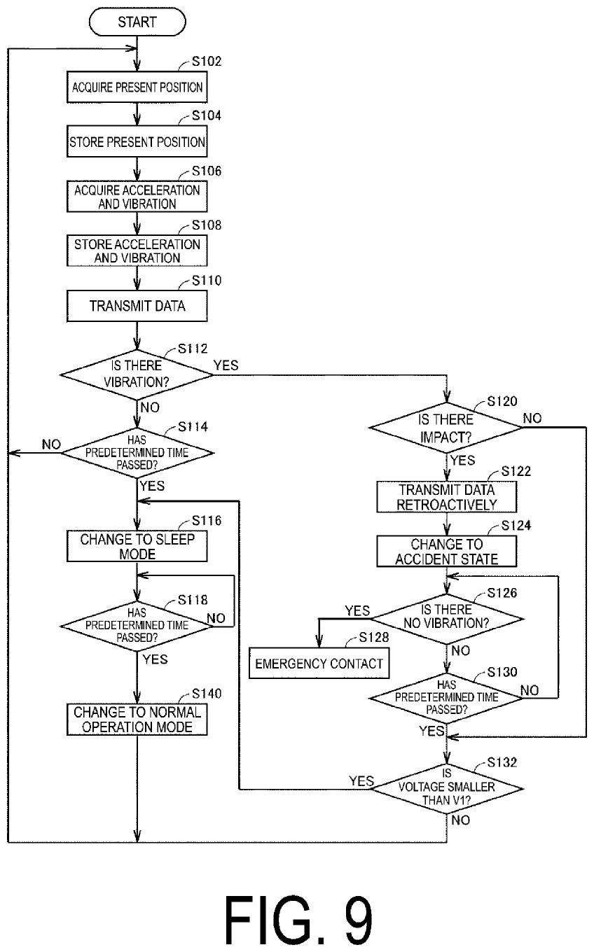

Hereinafter, with reference to FIG. 9, information processing related to switching between the normal operation mode and the sleep mode will be described. In the normal operation mode, the CPU 210 acquires the present position information using the position acquisition antenna 230 periodically, for example, every second (step S102). The 210 stores the present position information in the history data 221 (step S104).

The CPU 210 acquires the posture, vibration, and speed of the first communication terminal 200 or the vehicle 500 using the acceleration sensor 270 (step S106). The CPU 210 stores the posture, vibration, and speed of the first communication terminal 200 or the vehicle 500 in the history data 221 (step S108).

The CPU 210 transmits the present position information, the posture and vibration to the server 100 via the communication antenna 260 (step S110). In the present embodiment, the CPU 210 transmits the present position information every second, and collectively transmits the measurement data by the acceleration sensor 270 every 10 seconds. More specifically, the CPU 210 refers to the history data 221 every 10 seconds, calculates the maximum value, the minimum value, and the average value for each of the six axes of the measurement data by the acceleration sensor 270 for 10 seconds, and transmits the data to the server. Accordingly, in the present embodiment, the amount of data communication can be reduced.

The CPU 210 determines whether vibration is detected based on the measured value by the acceleration sensor 270 (step S112). When the CPU 210 does not detect vibration (NO in step S112), the CPU 210 determines whether a period of time in which vibration has not been detected reaches a first predetermined period of time, for example, 60 seconds (step S114). When the period of time in which vibration has not been detected does not reach the first predetermined period of time (NO in step S114), the CPU 210 repeats the pieces of processing from step S102.

When the period of time in which vibration has not been detected reaches the predetermined period of time (YES in step S114), the CPU 210 changes to the sleep mode (step S116). In other words, the CPU 210 suspends the position acquisition antenna 230 and the communication antenna 260, and continues to detect vibration by the acceleration sensor 270 and store the detected vibration.

The CPU 210 determines whether a second predetermined period of time, for example, 10 minutes, has passed (step S118). When the second predetermined period of time has passed, the CPU 210 returns to the normal operation mode (step S140). In other words, the CPU 210 activates the position acquisition antenna 230 and the acceleration sensor 270, and repeats the pieces of processing from step S102.

On the other hand, when the CPU 210 detects vibration based on the measured value by the acceleration sensor 270 (YES in step S112), the CPU 210 determines whether the vibration is larger than a predetermined value (step S120). When the vibration is larger than the predetermined value (step S120), the vehicle 500 or the like may have collided or fallen. Therefore, the CPU 210 refers to the history data 221 and transmits the detailed stored data including those before the predetermined period of time to the server 100 (step S122) and changes to an accident warning mode (step S124).

In the accident warning mode, it is preferable that the CPU 210, until a third predetermined period of time, for example, five minutes, elapses, store more detailed data such as the posture and vibration in the history data 221 via the acceleration sensor 270, and sequentially transmit the detailed data to the server 100 via the communication antenna 260 without storing the detailed data. When the third predetermined period of time, for example, five minutes, has passed, (YES in step S130), the CPU 210 cancels the warning mode and returns to the normal operation mode.

In the present embodiment, after changing to the warning mode, when the vibration-free time continues for a fourth predetermined time, for example, three minutes (YES in step S126), the CPU 210 notifies the server 100 via the communication antenna 260 that an abnormal situation has occurred (step S128). As a result, the server 100 can provide an abnormality that has occurred in the vehicle 500 and the present position of the vehicle 500 to a police server, an emergency server, and the like.

When no large vibration is detected (NO in step S120), the CPU 210 measures the voltage of the battery 501 via the battery voltage monitor 290 and determines whether the voltage is less than a predetermined value (step S132). When the voltage is less than the predetermined value (YES in step S132), the CPU 210 changes to the sleep mode (step S116). The CPU 210 suspends the position acquisition antenna 230 and the communication antenna 260, and continues to detect vibration by the acceleration sensor 270 and store the detected vibration.

Note that when the voltage is less than the predetermined value, in the sleep mode, it is preferable that the lower the voltage, the longer the CPU 210 sets an interval for activating the position acquisition antenna 230, the acceleration sensor 270, the communication antenna 260, and the like, that is, the predetermined time in step S118. For example, in the sleep mode, in a state in which data is not transmitted and/or received to/from the server 100, it is preferable to start up the acceleration sensor 270 and set a long interval for detecting vibration.

When the voltage is not less than the predetermined value (NO in step S132), the CPU 210 continues the normal driving mode and repeats the pieces of processing from step S102.

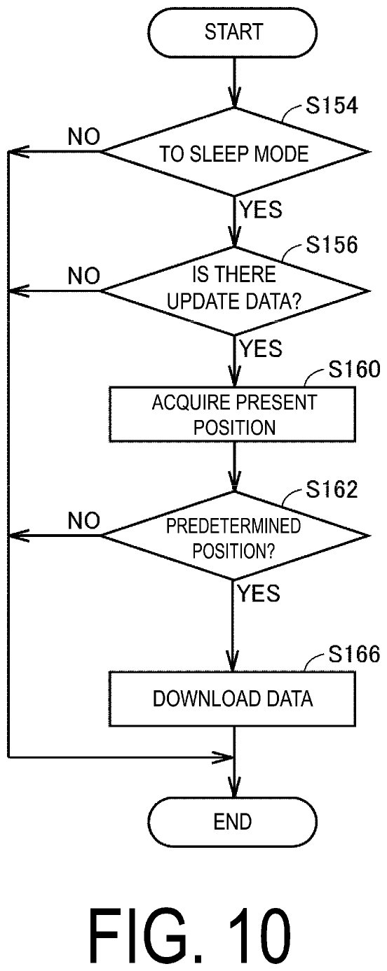

Next, with reference to FIG. 10, information processing when downloading and installing update data for a program such as firmware will be described.

In the present embodiment, the CPU 210 determines whether it is determined to change the normal operation mode to the sleep mode (step S154). When the CPU 210 determines to change to the sleep mode (YES in step S154), the CPU 210 refers to the update data flag to determine whether there is updated data for firmware or the like (step S156).

When there is update data (YES in step S156), the CPU 210 acquires the present position information using the position acquisition antenna 230 (step S160). The CPU 210 refers to the predetermined position data 224 to determine whether the present position matches the predetermined position or is in the vicinity of the predetermined position (step S162).

When the present position matches or is in the vicinity of the predetermined position (YES in step S162), the CPU 210 downloads and installs the program update data from the server 100 via the communication antenna 260 (step S166). The CPU 210 changes to the sleep mode.

### Configuration of Server 100

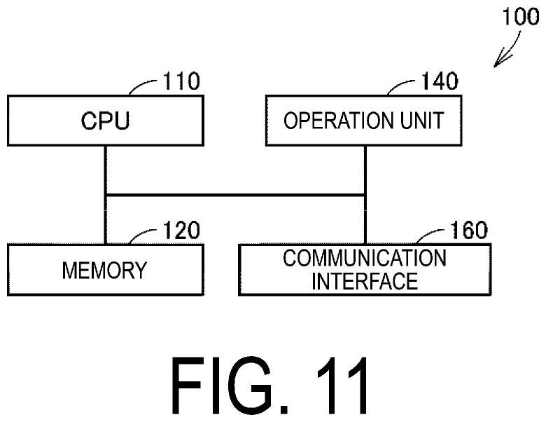

Next, a configuration of the server 100 in the network system 1 according to the present embodiment will be described. As illustrated in FIG. 11, the server 100 includes a central processing unit (CPU) 110, a memory 120, an operation unit 140, and a communication interface 160 as main components.

The CPU 110 provides a theft notification service while controlling the respective units of the server 100 by executing programs stored in the memory 120. For example, the CPU 110 performs various types of processing, which will be described below, by executing programs stored in the memory 120 and referring to various types of data.

The memory 120 may be practically configured by various types of RAM, various types of ROM, and the like. The memory 120 may be embedded in the server 100, may be removably attached to various interfaces of the server 100, or may be a database in another device accessible from the server 100. The memory 120 stores the programs that are executed by the CPU 110, data generated as a result of the CPU 110 executing the programs, user information data 121, history data 122, and the like.

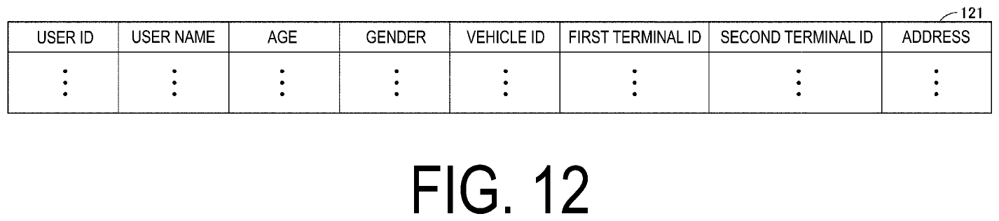

With reference to FIG. 12, the user information data 121 stores the correspondence between the identification information of the user registered in the vehicle state providing service, the name of the user, the age of the user, the gender of the user, the identification information of the vehicle 500 registered in the vehicle state providing service, the identification information of the first communication terminal 200, the identification information of the second communication terminal 300, the address of the user, and the like.

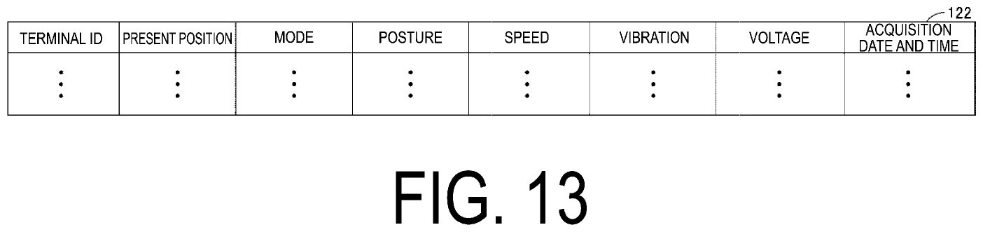

With reference to FIG. 13, the history data 122 stores, for each of the first communication terminals 200, a correspondence between the present position. information, the data indicating the orientation and inclination (posture) of the vehicle, the data indicating the speed, the data indicating the vibration of the vehicle 500, the data indicating the voltage of the battery 501, the acquisition date and time of the data, and the like.

Returning to FIG. 11, the operation unit 140 receives operation commands from a service administrator or the like, and inputs the received operation commands to the CPU 110.

The communication interface 160 transmits data from the CPU 110 to other devices such as the plurality of first communication terminals 200 and the plurality of second communication terminals 300 via the Internet, a carrier network, a router, or the like, In contrast, the communication interface 160 receives data from the other devices via the Internet, a carrier network, a router, or the like, and delivers the received data to the CPU 110.

### Information Processing in Server 100

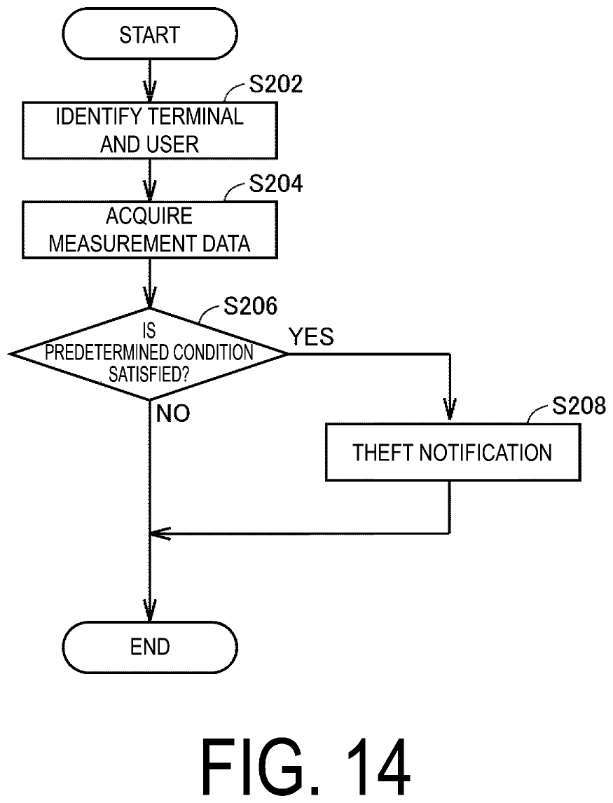

Next, information processing in the server 100 according to the present embodiment will be described with reference to FIG. 14. The CPU 110 of the server 100 executes the following pieces of processing when receiving data from the first communication terminal 200 via the communication interface 160.

First, the CPU 110 reads the identification information of the first communication terminal 200 from the received data transmitted from the first communication terminal 200, and identifies the user with reference to the user information data 121 (step S202). The CPU 110 acquires various measurement data from the received data transmitted from the first communication terminal 200 (step S204). For example, the CPU 110 acquires information indicating the voltage of the battery 501 of the vehicle 500 and information indicating the vibration of the vehicle 500.

Subsequently, the CPU 110 determines whether an abnormal situation occurs in the vehicle 500 based on the measurement data (step S206). For example, the CPU 110 determines whether the voltage of the battery of the vehicle 500 fluctuates to a predetermined value or more, for example, 5% or more, or determines whether the vehicle 500 vibrates. Subsequently, when the vehicle 500 vibrates even though the voltage of the battery of the vehicle 500 has hardly fluctuated, the CPU 110 determines that the vehicle 500 is likely to have been stolen (YES in step S206). Conversely, when the vehicle 500 does not vibrate, it is determined that the possibility of theft is low, and when the voltage of the battery 501 of the vehicle 500 fluctuates more than the predetermined value, it is determined that the possibility of theft is low. This determination method is particularly effective when the battery 501 of the vehicle 500 is charged by another driving force generator such as a gasoline engine.

As described above, when it is determined that the vehicle 500 has been stolen and carried (YES in step S206), the CPU 110 transmits a notification to the second communication terminal 300 of the user who owns the vehicle 500 via the communication interface 160 to the effect that the vehicle 500 is likely to have been stolen and carried (step S208). Note that at this time, it is preferable that the CPU 110 provide the user's second communication terminal 300 with the present position of the vehicle 500, measurement results, and the like.

The CPU 110 may also transmit a notification to the first communication terminal 200 itself via the communication interface 160 to the effect that the vehicle 500 is likely to have been stolen and carried. However, the first communication terminal 200 may locally determine whether the vehicle 500 has been stolen. For example, similarly to step S206, the CPU 210 of the first communication terminal 200 can determine that there is a high possibility that the vehicle 500 has been stolen when detecting vibration even though the engine is stopped, for example, the battery voltage is constant or the engine temperature is low. Alternatively, the CPU 210 can determine that there is a high possibility that the vehicle 500 has been stolen when the present position is moving even though the engine is stopped.

On the other hand, when it is determined that the vehicle 500 has not been stolen and has not been carried (NO in step S206), the CPU 110 waits for the next measurement data from the first communication terminal 200 via the communication interface 160.

### Configuration of Second Communication Terminal 300

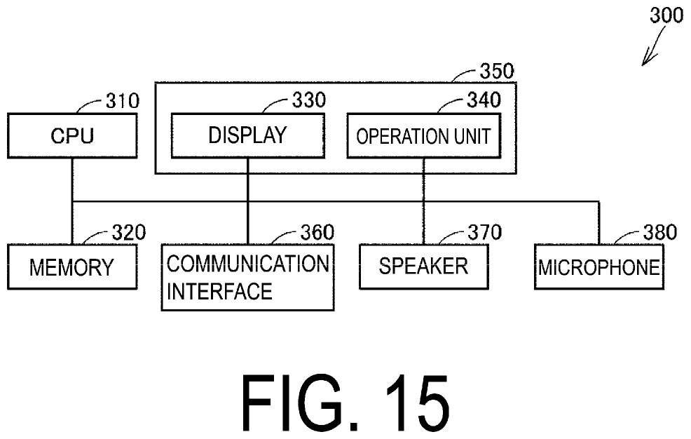

Next, an aspect of a configuration of the second communication terminal 300 included in the network system 1 will be described. The second communication terminal 300 is a device such as a smart phone, a wearable terminal, a tablet, a personal computer, or a speaker, and is capable of data communication with the server 100. As illustrated in FIG. 15, the second communication terminal 300 includes a CPU 310, a memory 320, a display 330, an operation unit 340, a communication interface 360, a speaker 370, a microphone 380, and the like as main components.

The CPU 310 controls the respective units of the second communication terminal 300 by executing a program stored in the memory 320 or an external storage medium.

The memory 320 is practically configured by various types of RAM, various types of ROM, and the like. The memory 320 stores programs to be executed by the CPU 310, data generated by the CPU 310 executing the programs, text data, image data, and voice data received from the server 100, data inputted via the operation unit 340, and the like.

The display 330 outputs characters, images, and the like based on signals from the CPU 310. The operation unit 340 receives commands from a user, and inputs the commands to the CPU 310. A touch panel 350 may be constituted of the display 330 and the operation unit 340.

The communication interface 360 is constituted of a communication module such as wireless LAN communication or wired LAN. The communication interface 360 transmits and/or receives data to/from another device such as the server 100 by wired communication or wireless communication.

The speaker 370 outputs audio based on the signals from the CPU 310. The microphone 380 creates audio signals based on audio from the outside and inputs the created audio signals to the CPU 310.

In the present embodiment, the CPU 310 receives the theft detection data from the server 100 via the communication interface 360. Based on the received data, the CPU 310 outputs a warning sound from the speaker 370, and causes the display 330 to output the possibility of theft, and a present position, a moving direction, a vibration level, a remaining battery level, and the like of the user's vehicle 500.

### Second Embodiment

In addition to the embodiment described above, when there is a high possibility that the vehicle 500 has been stolen, the CPU 210 of the first communication terminal 200 may make it difficult to change to the sleep mode, or may make it easy to change to the normal operation mode. As a result, the user, the manufacturer, the insurance company, the police, or the like can know the first communication terminal 200 and the vehicle 500 in detail even during sleep. For example, in step S132 of FIG. 9, when the theft flag is on, the CPU 210 may set a voltage threshold value low for changing to the sleep mode.

Alternatively, in step S114 of FIG. 9, when the theft flag is on, the CPU 210 makes it difficult to change to the sleep mode by setting the predetermined time long.

Alternatively, in step S118 of FIG. 9, by setting the predetermined time short, the CPU 210 may shorten the interval until returning to the measurement or transmission of the acceleration information or the present position information, or may increase the frequency of measurement of acceleration, the frequency of measurement of the present position, and the frequency of data transmission.

Alternatively, when there is a high possibility that the vehicle 500 has been stolen, the CPU 210 of the first communication terminal 200 may make it easy to change to the sleep mode or make it difficult to change to the normal operation mode. This makes it possible to reduce the drop in the battery level in the event of theft. For example, in step S132 of FIG. 9, when the theft flag is on, the CPU 210 may set a voltage threshold value high for changing to the sleep mode.

Alternatively, when the theft flag is on, the CPU 210 may make it easy to change to the sleep mode by setting the predetermined time short in step S114, or may lengthen the interval until returning to the measurement or transmission of the acceleration information or the present position information, or may reduce the frequency of measurement of acceleration, the frequency of measurement of the present position, or the frequency of data transmission by setting the predetermined time long in step S118.

### Third Embodiment

In addition to the embodiments described above, the CPU 210 of the first communication terminal 200 may further reduce a transmission frequency of the present position information, acceleration information, and the like when the change in acceleration during driving is small. As a result, the amount of data communication can be further reduced.

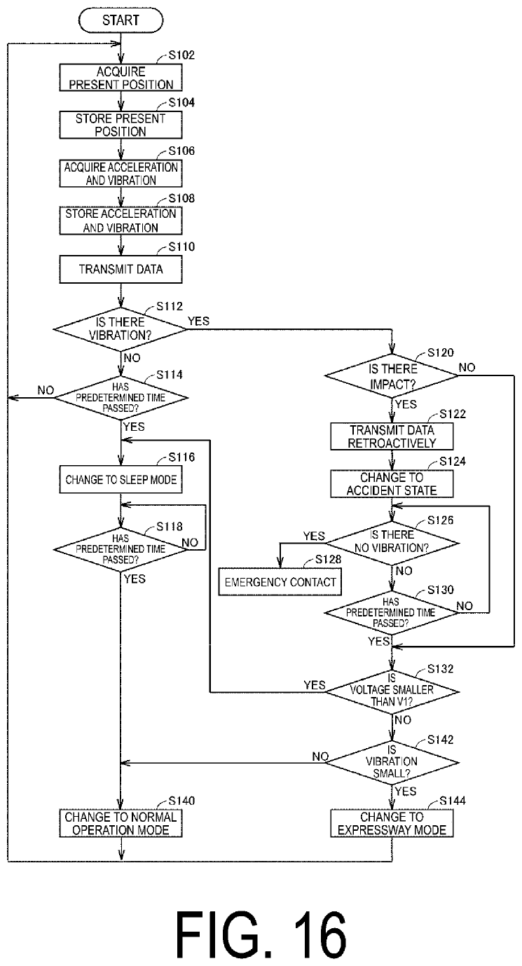

Specifically, as illustrated in FIG. 16, when a period of time in which the vibration is small continues for a predetermined time based on the measured value of the acceleration sensor 270 (YES in step S142), the CPU 210 turns on an expressway mode flag and changes to an expressway mode (step S144). When changing to the expressway mode, at a frequency less than that in the normal mode, that is, at intervals longer than those in the normal mode, the CPU 210 measures and stores the present position information, acceleration information, and the like using the position acquisition antenna 230, the six-axis acceleration sensor 270, and the like, or transmits the present position information, acceleration information, and the like to the server 100 via the communication antenna 260.

Note that when the period of time in which the vibration is small is not continued based on the measured value by the acceleration sensor 270 (NO in step S142), the CPU 210 turns off the expressway mode flag and returns to the normal operation mode (step S140).

### Fourth Embodiment

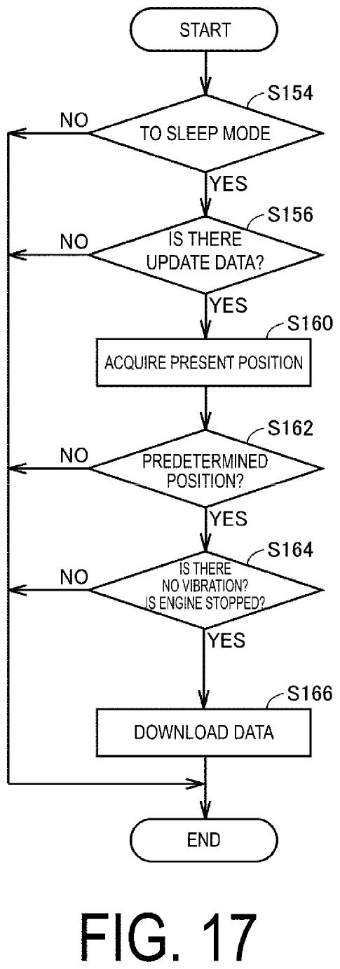

In addition to the embodiments described above, when there is update data, the CPU 210 of the first communication terminal 200 may determine whether to download the update data based on further another condition determination. For example, as illustrated in FIG. 17, the CPU 210 may download the update data after detecting that there is no vibration using the acceleration sensor 270 (YES at step S164) independently of the determination of the change to the sleep mode. In other words, the determination as to whether to change to the sleep mode may be made based on other than vibration.

Alternatively, the CPU 210 may download the update data after detecting that the engine of the vehicle 500 is stopped and detecting that there is no vibration using the acceleration sensor 270 (YES in step S164), independently of the determination of the change to the sleep mode.

### Fifth Embodiment

In addition to the embodiments described above, even when there is update data, when there is a possibility that the vehicle 500 has been stolen, it is preferable that the CPU 210 of the first communication terminal 200 do not download the update data. This makes it possible to reduce the drop in the battery level in the event of theft.

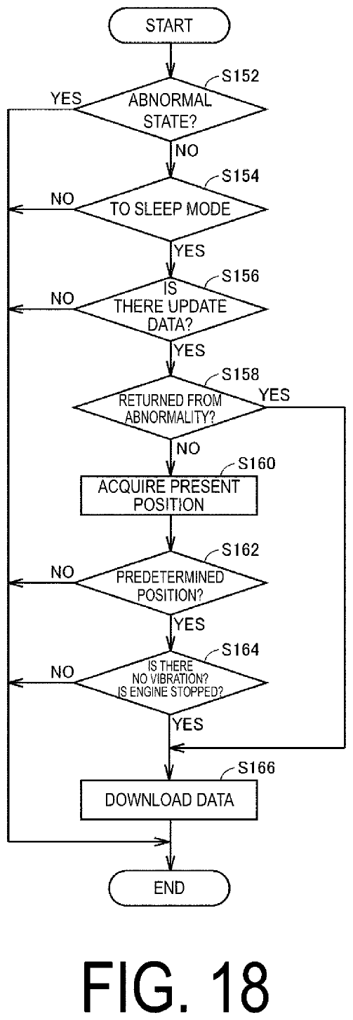

Specifically, as illustrated in FIG. 18, the CPU 210 does not download the update data in an abnormal state such as when the theft flag is turned on or when an accident occurs (YES in step S152). In the present embodiment, when the theft mode flag is off (NO in step S152), the CPU 210 determines whether it is determined to change from the normal operation mode to the sleep mode (step S154). When the CPU 210 determines to change to the sleep mode (YES in step S154), the CPU 210 determines whether there is update data (step S156).

When there is update data (YES in step S156), the CPU 210 determines whether the abnormal state has just been canceled (step S158). Note that the abnormal state may be canceled by the CPU 210 or may be canceled based on instructions by the server 100. When the abnormal state has just been canceled (YES in step S158), the CPU 210 downloads and installs the program update data from the server 100 via communication antenna 260 (step S166).

When it is not immediately after the theft mode is canceled (NO in step S158), the CPU 210 executes processing from step S160.

### Sixth Embodiment

Some or all of the roles of each of the devices of the network system 1 in the above-described embodiments may be performed by other devices. For example, another device may play a part or all of the roles of the server 100, the plurality of the first communication terminals, and the plurality of the second communication terminals 300, or a plurality of devices may play a part or all of the roles of the server 100, the plurality of the first communication terminals, and the plurality of the second communication terminals 300.

Further, as described in the embodiments described above, the method of determining the possibility of theft, the method of determining that the engine of the vehicle 500 is stopped, and the like can be selected as appropriate.

### Supplement

In the embodiments described above, a communication terminal including an acceleration sensor, a position acquisition antenna, a communication interface, and a processor is provided. The processor transmits acceleration information acquired using the acceleration sensor and present position information acquired using the position acquisition antenna in a normal operation mode via the communication interface, changes to an abnormal state when detecting a vibration equal to or higher than a first predetermined value using the acceleration sensor, and increases a frequency of the acquisition or transmission of the acceleration information or the present position information in the abnormal state.

Preferably, the communication terminal further includes a memory. The processor transmits some of the acceleration information and the present position information via the communication interface while storing the acceleration information acquired using the acceleration sensor and the present position information acquired using the position acquisition antenna in the normal operation mode in the memory, and when changing to the abnormal state, the processor transmits the stored acceleration information or the present position information retroactively before the change.

Preferably, the processor returns to the normal operation mode after a predetermined time elapses after changing to the abnormal state.

Preferably, after changing to the abnormal state, the processor gives a predetermined notification via the communication interface when the acceleration sensor does not detect vibration for a predetermined time or longer.

Preferably, in the normal operation mode, when continuing to detect vibrations equal to or smaller than a second predetermined value, which is smaller than the first predetermined value, for a predetermined time or longer using the acceleration sensor, the processor further reduces a frequency of acquisition or transmission of the acceleration information or the present position information.

The embodiments disclosed here are to be understood as being in all ways exemplary and in no way limiting. The scope of the present invention is defined not by the foregoing descriptions but by the appended claims, and is intended to include all changes equivalent in meaning and scope to the claims.

### REFERENCE SIGNS LIST

1 Network system
100 Server
110 CPU
120 Memory
121 User information data
122 History data
140 Operation unit
160 Communication interface
200 First communication terminal
210 CPU
220 Memory
221 History data
222 Flag data
223 Parameter data
224 Predetermined position data
230 Position acquisition antenna
260 Communication antenna
270 Six-axis acceleration sensor
280 DC/DC converter
290 Battery voltage monitor
300 Second communication terminal
310 CPU
320 Memory
330 Display
340 Operation unit
350 Touch panel
360 Communication interface
370 Speaker
380 Microphone
500 Vehicle
501 Battery

1. A communication terminal comprising:
an acceleration sensor;
a position acquisition antenna;
a communication interface; and
a processor,
wherein the processor transmits acceleration information acquired using the acceleration sensor and present position information acquired using the position acquisition antenna in a normal operation mode via the communication interface, changes to an abnormal state when detecting a vibration equal to or higher than a first predetermined value using the acceleration sensor, and increases a frequency of acquisition or transmission of the acceleration information or the present position information in the abnormal state.

2. The communication terminal according to claim 1, the communication terminal further comprising:
a memory,
wherein the processor transmits some of the acceleration information and the present position information via the communication interface while storing the acceleration information acquired using the acceleration sensor and the present position information acquired using the position acquisition antenna in the normal operation mode in the memory, and when changing to the abnormal state, the processor transmits the stored acceleration information or the present position information retroactively before the change.

3. The communication terminal according to claim 12,
wherein the processor returns to the normal operation mode when a predetermined time elapses after changing to the abnormal state.

4. The communication terminal according to claim 1,
wherein after changing to the abnormal state, the processor gives a predetermined notification via the communication interface when the acceleration sensor does not detect vibration for a predetermined time or longer.

5. The communication terminal according to claim 1,
wherein, in the normal operation mode, when continuing to detect vibrations equal to or smaller than a second predetermined value, which is smaller than the first predetermined value, for a predetermined time or longer using the acceleration sensor, the processor further reduces a frequency of acquisition or transmission of the acceleration information or the present position information.
